(19) United States
(12) Patent Application Publication
(10) Pub. No.: US 2026/0060337 A1
(43) Pub. Date: Mar. 5, 2026

(54) BREAST TISSUE SUPPORT DEVICE

(71) Applicants: Brittiney S. Borchardt, Anchorage, AK (US); Rudolph Charles Borchardt, Anchorage, AK (US)

(72) Inventors: Brittiney S. Borchardt, Anchorage, AK (US); Rudolph Charles Borchardt, Anchorage, AK (US)

(21) Appl. No.: 19/316,982

(22) Filed: Sep. 2, 2025

Related U.S. Application Data
(60) Provisional application No. 63/690,006, filed on Sep. 3, 2024.

(51) Int. Cl. A41C 3/00; A41C 3/06; A61H 7/00

(52) U.S. Cl. CPC A41C 3/0064; A41C 3/065; A61H 7/001; A61H 2201/165; A61H 2201/1695; A61H 2205/082

(57) ABSTRACT

A breast tissue support device is disclosed and may include an elastic fabric having an exposed side and a skin side and an adhesive disposed on the skin side of the elastic fabric. The adhesive may be configured to adhere the breast tissue support device to human skin. The breast tissue support device may include a center portion free from adhesive that is sized to surround a human nipple.

### BACKGROUND

### Technical Field

The present disclosure relates generally to breast tissue support devices, specifically breast tissue support devices configured to stimulate a user's lymphatic system.

### Description of the Related Art

Traditional bras are commonly coupled to the user by way of at least one strap which encircles at least one of a torso or a shoulder of the user. Additionally, traditional bras commonly include an underwire extending across the chest of the user. Such a bra commonly places a great deal of stress on the back and/or shoulders of the user, which may lead to back and/or posture issues. Additionally, because of the excessive hardware required for straps, underwires, etc., traditional bras place a great deal of compression on the user and may restrict the user's ability to freely move.

Furthermore, the compression of traditional bras can constrict lymphatic vessels extending through breast tissue, which may impede the flow of lymphatic fluid throughout the lymphatic system. Lymphatic fluid in the breast ideally flows from an area of the nipple outward to axillary lymph nodes, which are located near the armpits. The lymphatic system provides an important role in the body, such as removing waste products from bodily tissues. The restriction of lymphatic fluid flow can lead to several undesirable conditions, including but not limited to lymphedema, increased risk of infections, fibrosis, and circulatory problems. Incorrectly sized bras may further exacerbate these lymphatic effects of bras. Unfortunately for users of bras, bras are limited in their size offerings, which may not allow for proper sizing of a bra on both breasts when the breasts are not identically shaped or sized.

Additionally, common bras may weaken and deform the cooper's ligament. Weakening and deforming the cooper's ligament may be at least partly responsible for a breast failing to maintain its shape. Properly fitting and supporting alternatives to bras may assist in repairing and maintaining the cooper's ligament.

Although bras lacking straps are found on the market, these offerings fail to rectify the issues listed above and are primarily designed with aesthetic design at the forefront. Current adhesive bra offerings do not enhance lymphatic fluid flow throughout the breast area and also do not support the shape of breasts.

### BRIEF SUMMARY

Embodiments described herein include a breast tissue support device that is configured to provide improved support to a user of the device alongside other benefits.

A breast tissue support device according to an example embodiment may be summarized as including an elastic fabric having an exposed side and a skin side, and an adhesive disposed on the skin side of the elastic fabric. The adhesive may be configured to adhere the breast tissue support device to human skin. The breast tissue support device may include a center portion free from adhesive that is sized to surround a human nipple.

In some embodiments, the breast tissue device may include a stimulator configured to promote lymphatic flow. The lymphatic stimulator may be arranged in one or more at least partial rings extending radially from a designated focal point. The lymphatic stimulator may be configured to promote lymphatic flow in a radial direction from a designated focal point. The lymphatic stimulator may be configured to promote lymphatic flow by massaging a portion of a lymphatic system adjacent to the breast tissue support device.

In some embodiments, the breast tissue support device may include an infusion material infused into the elastic fabric and/or the lymphatic stimulator.

Embodiments described herein also disclose a breast tissue support device included as part of a clothing article.

Although aspects of some of the embodiments disclosed herein are described in the context of breast tissue support device, it is appreciated that aspects may be utilized in a variety of locations on a body of a user.

### BRIEF DESCRIPTION OF THE SEVERAL VIEWS OF THE DRAWINGS

FIG. 1 shows a plan view of a skin side of an exemplary breast tissue support device according to an exemplary embodiment of the present disclosure.

FIG. 2 shows a section view of the breast tissue support device of FIG. 1 along section-line 2-2.

FIG. 3 shows a front view of a user wearing a pair of breast tissue support devices.

FIG. 4 shows a side view of a user wearing a breast tissue support device.

FIG. 5 shows a front view of a user wearing a clothing article incorporating a breast tissue support device.

FIG. 6 shows a plan view of a skin side of an exemplary breast tissue support device including a backing thereon according to an exemplary embodiment of the present disclosure.

FIG. 7 shows a plan view of a skin side of an exemplary breast tissue support device according to an embodiment of the present disclosure without lymphatic stimulus beads.

FIG. 8 shows a plan view of a skin side of an exemplary breast tissue support device having a horizontal adhesive pattern according to another embodiment of the present disclosure.

FIG. 9 shows a plan view of a skin side of an exemplary breast tissue support device having a vertical adhesive pattern according to another embodiment of the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and techniques associated with breast tissue support devices may not be shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

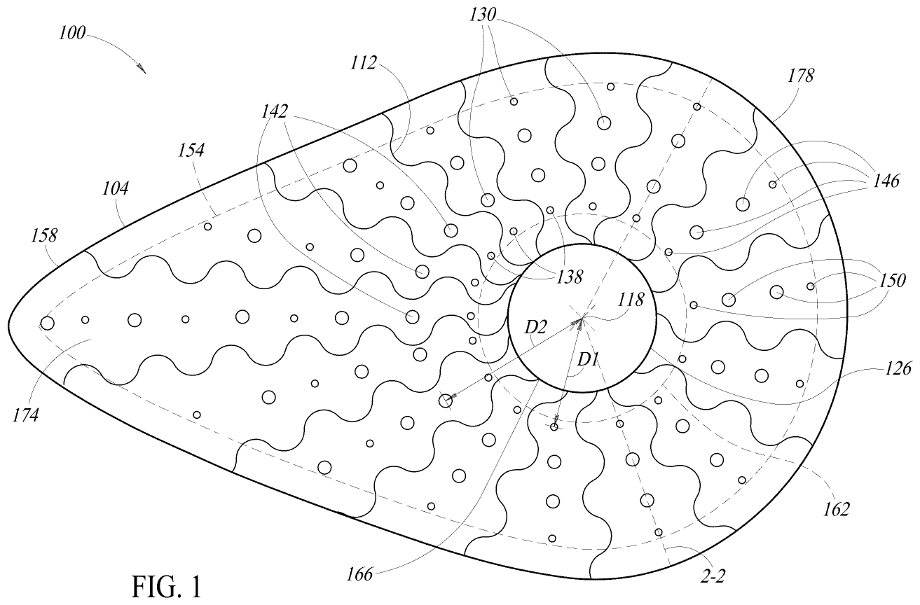

FIG. 1 shows a plan view of a breast tissue support device 100 as described herein. The breast tissue support device 100 is configured to be disposed on a breast of a user 102 in order to provide support to the breast of the user 102. Additionally, the breast tissue support device 100 may provide increased lymphatic drainage, reduction in fluid retention of the breast tissue, and improved blood circulation.

FIG. 1 shows a skin side 104 of the breast tissue support device 100, which is configured to be placed against skin of the user 102 when applied. The breast tissue support device 100 includes an elastic fabric 108 and an adhesive 112.

The elastic fabric 108 includes an exposed side 116 and the skin side 104. The exposed side 116 is configured to face away from the user 102 when applied. The elastic fabric 108 may be configured to have a stretch capacity of about 60% to about 80% of a resting length of the elastic fabric 108. In some embodiments, the elastic fabric 108 may be configured to have a stretch capacity of about 62% to about 78% of a resting length of the elastic fabric 108. In some embodiments, the elastic fabric 108 may be configured to have a stretch capacity of about 65% to about 75% of a resting length of the elastic fabric 108. The stretch capacity may enable the elastic fabric 108 to create a gentle lifting effect by creating tension on the skin. The gentle lifting effect may assist in improving blood circulation and lymphatic drainage without causing discomfort or overly restricting movement.

The elastic fabric 108 may provide breathable functionality. Breathable functionality refers to the ability of the material to allow air to substantially move effectively therethrough. In some embodiments, the elastic fabric may waterproof, water-resistant, and/or moisture wicking. The elastic fabric 108 may comprise a plurality of materials. In some embodiments, the elastic fabric 108 may comprise at least one of cotton, nylon, polyester, rayon, spandex (i.e., elastane), bamboo, hemp, lyocell, modal, polyurethane, thermoplastic polyurethane, silk, fibroin, jersey, an elastomeric binder, PLA, and PBAT, or any other suitable material. In some embodiments, the elastic fabric 108 may be weft knit, warp knit, or any other suitable knit. The exposed side 116 of the elastic fabric 108 may include cosmetic designs thereon. In some embodiments, the elastic fabric 108 may include an exterior film on the skin side 104 and/or the exposed side 116.

In some embodiments, a weight of the elastic fabric 108 may be 120-180 grams per square meter, for example, when the elastic fabric 108 comprises cotton and/or rayon. In some embodiments, the weight of the elastic fabric 108 may be 90-150 grams per square meter, for example, when the elastic fabric 108 comprises synthetic materials.

In some embodiments, the elastic fabric 108 may have a vapor transmission rate of at least 1,500 g/m² per 24 hours.

In some embodiments, the elastic fabric 108 may include any of copper, silver, graphene, tourmaline, activated charcoal, zinc, and ceramic. Inclusion of any of these materials may enhance function of the breast tissue support device 100, for example, by reducing odors, improving thermal conductivity, and absorbing moisture.

The adhesive 112 is disposed on the skin side 104 of the elastic fabric 108. The adhesive 112 is configured to adhere the breast tissue support device 100 to the skin of the user 102. Specifically, the adhesive 112 may be configured to adhere the breast tissue support device 100 to a breast area of the user 102. In some embodiments, the adhesive 112 may include at least one of acrylic pressure sensitive adhesive, silicone gel, hydrogel, hydrocolloid, or any other suitable adhesive. In some embodiments, the adhesive may cover any of 30%-60% of the breast tissue support device 100, 35%-55% of the breast tissue support device 100, or 40%-50% of the breast tissue support device 100.

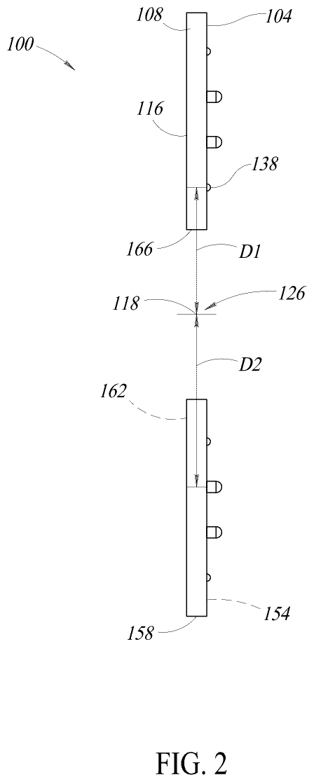

The adhesive 112 may be disposed in a “wave” pattern, such that the adhesive 112 is configured to have peaks and valleys. The wave pattern may extend radially outward from a designated focal point 118 of the breast tissue support device 100. The designated focal point 118 may be used as a reference point for various features of the breast tissue support device 100. In some embodiments, the designated focal point 118 may be coincident with a nipple region 122 of the breast of the user 102. The radial extension of the adhesive 112 may align with a desired flow direction of lymph fluid, i.e., away from bodily tissues and toward lymph nodes. In the example embodiment shown in FIG. 1, the adhesive 112 extends from the nipple region 122 toward an armpit region 124. In some embodiments, the adhesive 112 may radiate from the designated focal point 118 while configured as a wave pattern. Such an embodiment may improve adhesion and enhance breathability. Although the adhesive 112 extends radially outward from the designated focal point 118 in the embodiment shown in FIGS. 1 and 2, the adhesive 112 may be disposed in any configuration, including waves extending in the horizontal direction and/or in the vertical direction.

In some embodiments, the adhesive 112 may extend horizontally, vertically, diagonally, or any direction across the elastic fabric 108. In embodiments in which the adhesive 112 extends across the elastic fabric 108, the adhesive may be configured as a wave pattern. In other embodiments, the adhesive 112 may be disposed in patterns including at least one of ribs (i.e., stripes) in any direction, micro-dot arrays, grids, meshes, chevrons, or any other suitable design.

The adhesive 112 may be a “thermal adhesive,” such that the adhesive 112 provides a stronger adhesion force when heat is applied thereto. For example, the adhesive 112 may impart partial adhesion upon first application, but body heat from the user 102 may further enhance the adhesive properties of the adhesive 112. Such an adhesive 112 enables improved adhesion of the breast tissue support device 100 to the user 102, especially during periods of extended use.

An example breast tissue support device 100 may include an elastic fabric 108 comprising 70% bamboo, 22% cotton, and 8% spandex, with the adhesive 112 comprising silicone gel. In another example, the breast tissue support device 100 may include an elastic fabric 108 comprising 60% hemp, 34% lyocell, and 6% spandex, with the adhesive 112 comprising acrylic pressure sensitive adhesive. In another example, the breast tissue support device 100 may include 92% nylon and 8% spandex, with the adhesive 112 comprising silicone gel. In yet another example, the breast tissue support device 100 may include an elastic fabric 108 comprising 50 % silk fibroin, 30% polyurethane, and 20% thermoplastic polyurethane microfibers, with the adhesive 112 comprising silicone gel.

The adhesive 112 may be applied to the elastic fabric 108 by way of at least one of knife-over-roll coating, slot-die coating, reverse-roll coating, gravure, flexographic coating, rotary screen print, curtain coating, web spraying, hot-melt bead extrusion, transfer coating, UV-cured silicone gel casting, calendered hydrocolloid and/or hydrogel layer, or any other suitable method.

Heat or UV radiation may be applied to the adhesive 112 to cure the adhesive 112 onto the breast tissue support device 100.

Additionally, the elastic fabric 108 may include an infrared generating material incorporated therein. The infrared generating material may be configured to be activated by body heat emitted by the user 102. When activated, the infrared generating material may emit infrared energy. Such infrared energy may be emitted to the user 102 to potentially improve circulation and oxygenation in an area of the elastic fabric 108.

In some embodiments, the breast tissue support device 100 may include an aperture 126 extending through the elastic fabric 108. The aperture 126 may be configured to enable a human nipple to pass therethrough. In other words, a user's nipple may not be covered by the breast tissue support device 100 and may instead be surrounded by the elastic fabric 108. The designated focal point 118 may be coincident with the aperture 126, such that elements which are positioned relative to the designated focal point 118 may also be considered to be positioned relative to the aperture 126.

Alternatively, in some embodiments, the breast tissue support device 100 may not include an aperture, but may be configured such that the elastic fabric 108 extends across the nipple of the user 102. In such embodiments, the elastic fabric 108 may be devoid of adhesive 112 in an area of the nipple (e.g., where the aperture 126 is present in FIG. 1). This configuration may be preferable to the user 102 with regard to comfort while preventing unwanted irritation of the nipple. In such embodiments, the elastic fabric 108 in the area of the nipple may be free of beads of the plurality of beads 130.

In some embodiments, the breast tissue support device 100 may include a plurality of lymphatic stimulators 130 thereon, which may be configured to stimulate the user's lymphatic system. It should be understood that although the lymphatic stimulators 130 are referred to as beads herein, the lymphatic stimulators may be any object which enhances lymphatic drainage by way of providing pressure against the user 102. In some embodiments, each bead of the plurality of beads 130 may have a thickness between any of 0.2-2 mm, 0.5-1.7mm, or 0.8-1.4 mm. The plurality of beads 130 may promote lymphatic flow by massaging a portion of a lymphatic system adjacent to the breast tissue support device 100. For example, the plurality of beads 130 may press against the user 102 when the breast tissue support device 100 is applied. Such massaging may be enhanced by movement by the user 102 when the breast tissue support device 100 is applied. Such massaging may enable the plurality of beads to enhance blood circulation and facilitate lymphatic flow. Additionally, movement may enable the plurality of beads 130 to stretch skin of the user 102 enabling improved lymphatic flow.

The plurality of beads 130 may be arranged in one or more at least partial rings extending radially from the designated focal point 118. For example, as shown in FIG. 1, a first ring 138 of beads 130 are a first distance D1 away from the designated focal point 118. A second ring 142 of beads are a second distance D2 away from the designated focal point 118. Any number of rings may be included, provided there is sufficient space for such a desired number of rings. The plurality of beads 130 may be arranged such that the beads 130 extend radially from the designated focal point 118 in rows. For example, FIG. 1 shows a first radial row 146 of beads 130 and a second radial row 150 of beads 130. Any number of rows may be included, provided there is sufficient space for such a desired number of rows.

A configuration of the plurality of beads 130 in rings and/or rows may promote lymphatic flow in a radial direction from the designated focal point 118 and toward lymph regions of the user 102. Such an enhancement may stimulate lymphatic flow along natural pathways of the breast area, further increasing a benefit provided by the breast tissue support device 100.

It should be understood that the plurality of beads 130 may be configured in other layouts which may align with a specific user's lymph pattern. For example, a user may have had certain lymph nodes removed, and the plurality of beads 130 may be arranged to align with a lymph flowpath of that individual user's lymphatic system.

The plurality of beads 130 may be configured such that none of the plurality of beads 130 are coincidental with the adhesive 112. For example, in the embodiment shown in FIG. 1, the radial rows of beads 130 extend between the wave patterns of the adhesive 112. Avoiding coincidence of the plurality of beads 130 and the adhesive 112 enables improved adhesion of the breast tissue support device 100 to the user 102 and enables freedom of movement of the user 102 while wearing the breast tissue support device 100.

The plurality of beads 130 may include beads 130 having a plurality of sizes. Such sizes of beads 130 can be seen in both FIG. 1 and the side cross-sectional view of the breast tissue support device 100 of FIG. 2. The varying sizes of the plurality of beads 130 may further enhance a massaging effect provided by the plurality of beads 130 due to varying pressure applied to the user 102 by the different sizes of beads 130. Such varying sizes of the plurality of beads 130 may be dictated by a pattern extending radially from the designated focal point 118. For example, the embodiment shown in FIGS. 1 and 2 includes the first ring 138 of beads 130 being of a first size, the second ring 142 and a third ring 146 of beads 130 being of a second size, and a fourth ring of beads 150 being of the first size. Such a pattern may provide a “massaging effect” on the lymphatic system of the wearer of the breast tissue support device 100. Such a massaging effect may mimic the effect of manual lymphatic drainage and support proper draining of the lymphatic system.

The plurality of beads 130 may be affixed to the skin side 104 of the breast tissue support device 100, as shown in FIG. 2, such that the plurality of beads 130 extend toward the user 102 when the breast tissue support device 100 is applied. In some embodiments, the plurality of beads 130 may be embedded within the elastic fabric 108, such that the elastic fabric 108 surrounds the plurality of beads 130.

In the embodiment shown in FIG. 2, each bead of the plurality of beads 130 may be hemispherical or dome-shaped, such that a rounded side of each bead 130 extends toward the user 102 when the breast tissue support device 100 is applied. Such a shape enables even pressure distribution across a surface area in contact with the skin, which may provide enhanced comfort and more effective lymphatic stimulation.

The plurality of beads 130 may be distributed such that none of the beads 130 are disposed in an exterior border region 154 of the elastic fabric 108. The exterior border region 154 may be a space within a predetermined distance of an exterior edge 158 of the elastic fabric 108. Exclusion of beads 130 from the exterior border region 154 may enable improved adhesion of the skin side 104 of the elastic fabric 108 to the user 102 of the breast tissue support device 100.

Similarly, the plurality of beads 130 may be distributed that none of the beads 130 are disposed in an aperture adjacent region 162 of the elastic fabric 108. The aperture adjacent region 162 may be a space within a predetermined distance of a defining edge 166 of the aperture 126. Exclusion of beads 130 from the aperture adjacent region 162 may enable improved adhesion of the skin side 104 of the elastic fabric 108 to the user 102 of the breast tissue support device 100.

Each of the plurality of beads 130 may comprise silicone. Additionally or alternatively each of the plurality of beads 130 may include a hypoallergenic material.

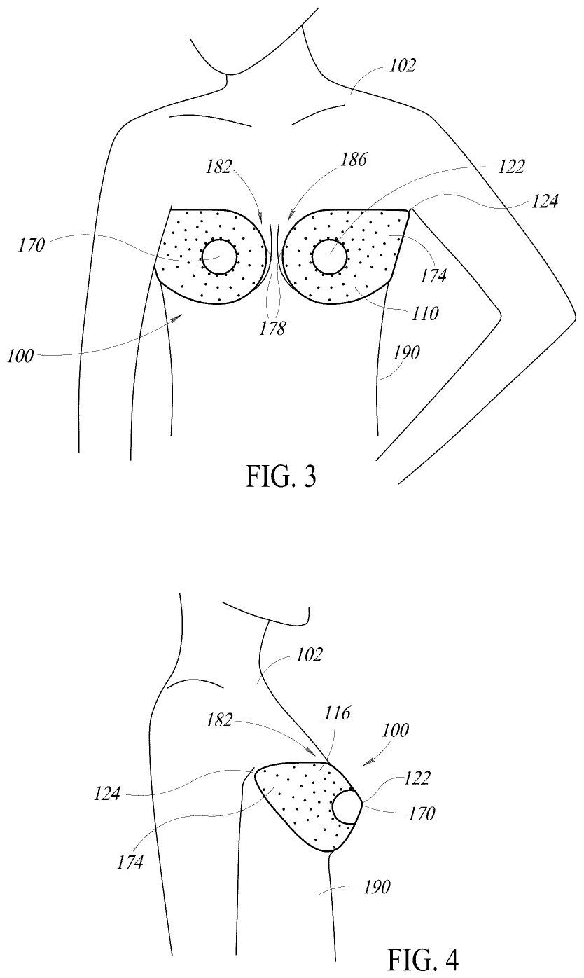

As shown in FIGS. 3 and 4, the breast tissue support device 100 may extend at least from a nipple section 170 of the user 102 to the armpit region 124 of the user 102, such that the breast tissue support device 100 covers at least a portion of a breast of the user 102. To accomplish such an extension, the breast tissue support device 100 may include “wing” sections 174, which extend toward the armpit region 124 of the user 102. The extension of the breast tissue support device 100 from the nipple section 170 to the armpit region 124 aligns with a natural lymphatic flowpath of lymph fluid from the nipple section 170 to lymph nodes of the armpit region 124, such as axillary lymph nodes.

The breast tissue support device 100 may extend at least from the nipple section 170 of the user to a center chest region 178 of the user 102. The extension of the breast tissue support device 100 from the nipple section 170 to the center chest region 178 aligns with another natural lymphatic flowpath of lymph fluid from the nipple section 170 to lymph nodes of the center chest region 178, such as parasternal lymph nodes.

The breast tissue support device 100 may be configured to cover a portion of only a first breast 182 of the user 102 or may be configured to cover a portion of both the first breast 182 and a second breast 186 of the user 102. In other words, the breast tissue support device 100 provides support and/or lymphatic stimulation to one of the user's breasts or both of the user's breasts. When the breast tissue support device 100 is configured to cover a portion of both breasts 182, 186, the breast tissue support device may be a single component bridging across the space between the breasts 182, 186.

The breast tissue support device 100 may be configured such that it does not extend completely around a torso 190 of the user 102. Such complete extension around the torso 190 may not be necessary due to the adhesion of the breast tissue support device 100 to the user 102. The adhesion may eliminate the need for straps, or other forms of fabric wraps, to ensure placement of the breast tissue support device 100 on the user 102.

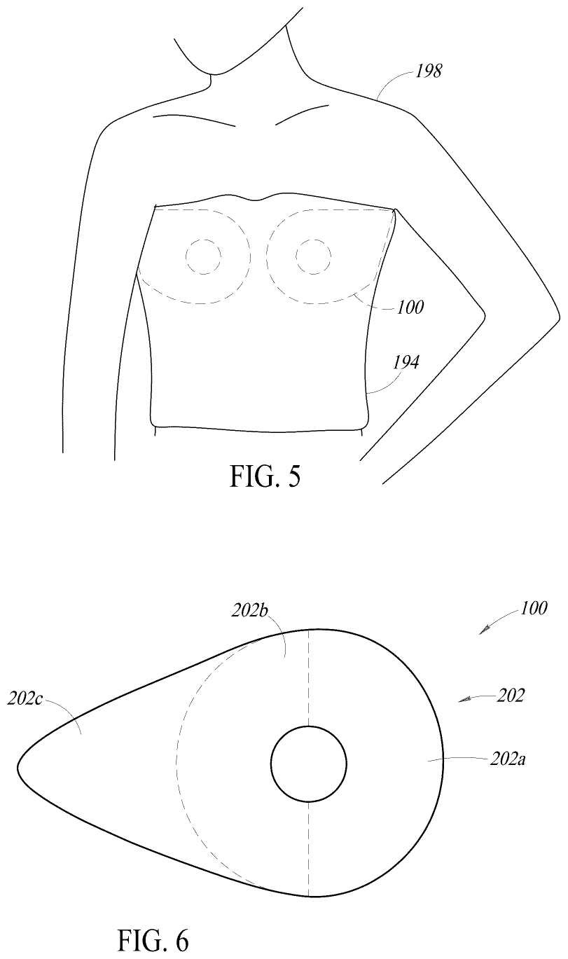

However, in some embodiments, the breast tissue support device 100 may be incorporated into a clothing article 194 which does extend around the torso 190 of the user 102, such as in the embodiment shown in FIG. 5. In such embodiments, the breast tissue support device 100 may still include the adhesive 112 coupling the breast tissue support device 100 to the user 102 in a specific position. The adhesive 112 may remove or reduce stress placed on the user 102 by the clothing article 194. For example, the clothing article 194 may extend around the torso 190 of the user 102, but the clothing article 194 may not require straps placing stress on the user's shoulders 198 and/or back.

Prior to application of the breast tissue support device 100 on the user 102, the breast tissue support device 100 may include a backing 202 covering the skin side 104 of the breast tissue support device 100, such as the backing 202 shown in FIG. 6. The backing 202 may comprises a sheet of paper, wax paper, or similar material, which covers the skin side 104 of the breast tissue support device 100. The backing 202 may prevent unintended coupling of the breast tissue support device 100 to an object due to the adhesive 112 contacting the object. The backing 202 may also assist the user 102 in applying the breast tissue support device 100 on the user's skin. In this regard, the backing 202 may include three portions 202a, 202b, 202c, which are separated from one another by way of a serrations. The serrations may enable the user 102 to remove one of the portions 202a, 202b, 202c of the backing 202, without removing other portions 202a, 202b, 202c of the backing 202. Such a configuration may enable the user 102 to more accurately apply the breast tissue support device 100. For example, the user 102 may initially only remove portion 202a of the backing 202 and place the exposed portion of the skin side 104 of the breast tissue support device 100 (i.e., the portion previously covered by the backing portion 202a), in a desired position. The desired position may ensure that portions of the skin side 104 of the breast tissue support device 100 covered by backing portions 202b, 202c are preliminarily placed in the correct position without adhering such portions 202b, 202c to the user 102. It should be understood that such an application may begin with removing any of the portions 202a, 202b, 202c of the backing 202.

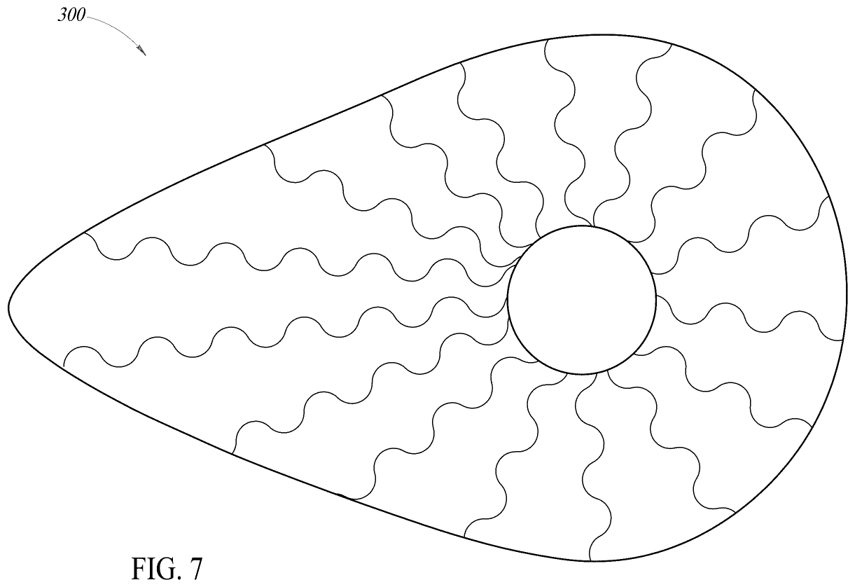

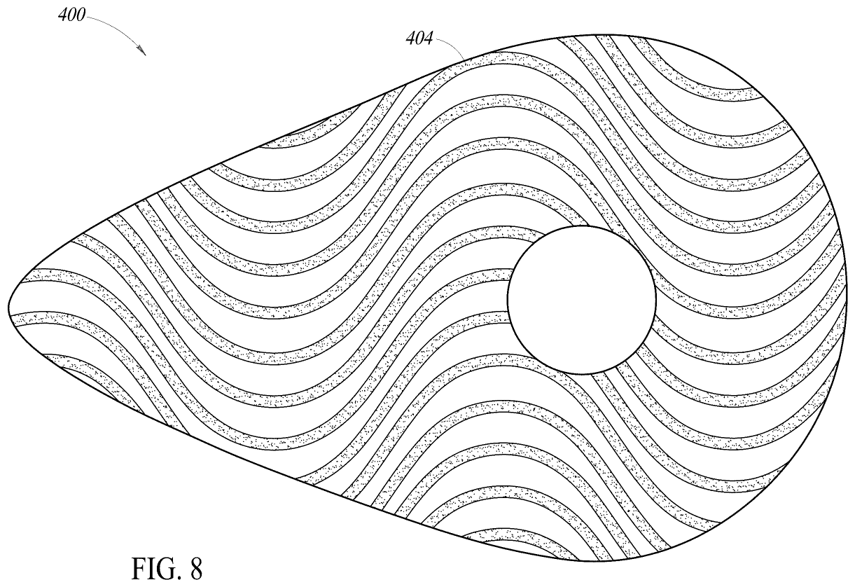

An alternative embodiment of a breast tissue support device 300 is shown in FIG. 7. The breast tissue support device 300 is configured similarly to the breast tissue support device 100 shown in FIGS. 1-5, but the breast tissue support device 300 does not include a lymphatic stimulator (e.g., beads 130). In such an embodiment, the breast tissue support device 300 may still provide lymphatic stimulus, but the extent of such stimulus may be less than that of the breast tissue support device 100. The lymphatic stimulus provided by the breast tissue support device 300 may be provided by way of a lifting effect on the skin without lymphatic stimulators, which may improve some users'comfort when using the breast tissue support device 300.

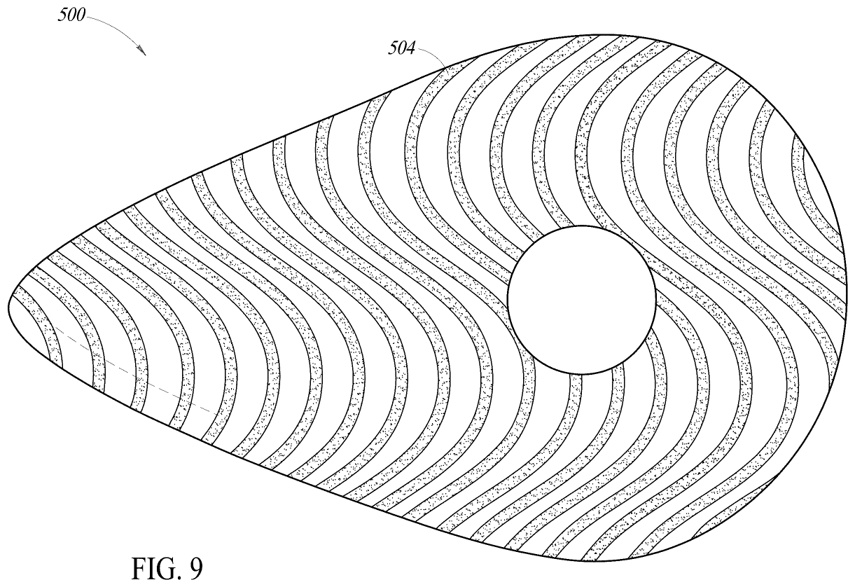

Additional embodiments of breast tissue support devices 400, 500 are shown in FIGS. 8 and 9, respectively. Each of the breast tissue support devices 400, 500 are similar to the breast tissue support device, such that neither of the breast tissue support devices 400, 500 include a lymphatic stimulating device. However, the breast tissue support devices 400, 500 differ by including adhesive patterns which do not extend outwardly from a center portion. For example, the breast tissue support device 400 of FIG. 8 includes adhesive 404 extending horizontally across the breast tissue support device 400 in a wave-like fashion. The breast tissue support device 500 includes adhesive 504 extending vertically across the breast tissue support device 500 in a wave-like fashion.

In any of the embodiments described above, but described with reference to the breast tissue support device 100 of FIGS. 1-5, infusion materials may be infused into the elastic fabric 108 and/or the lymphatic stimulators 130. In some embodiments, the infusion materials may be infused throughout the breast tissue support device 100, only in a portion thereof. The infusion materials may be delivered by way of fabric microcapsules, hydrogel micro-prints, and/or drug-in-adhesive matrices. In some embodiments, the infusion materials may be embedded directly in the elastic fabric 108. The infusion materials may be configured to provide additional benefits or to enhance already-described benefits, such as improving skin hydration, skin elasticity, circulation, and overall skin health. In some embodiments, the infusion materials may include any of antioxidants, anti-aging materials, anti-inflammatory materials, adaptogenic materials, hormonal support materials, and/or natural oils and extracts. The infusion materials may include at least one of hyaluronic acid, collagen peptides, vitamin E (tocopherol), vitamin C (ascorbic acid), coenzyme Q10, resveratrol, caffeine, gotu kola extract, dimethylaminoethanol, aloe vera, chamomile extract, calendula extract, horse chestnut extract (escin), ginkgo bilboa extract, ceramides, niacinamide (vitamin B3), bakuchiol, evening primrose oil, black cohosh extract, red clover extract, roseship seed oil, pomegranate seed oil, sea buckthorn oil, copper peptides, botanical extracts, menthol, ginger root extract, or any other suitable infusion material.

The infusion materials may be infused into the elastic fabric 108 and/or the lymphatic stimulators 130 before, during, and/or after application of the adhesive 112. The infusion materials may be infused into the elastic fabric 108 and/or the lymphatic stimulators 130 before, during, and/or after any curing of the adhesive 112.

A breast tissue support device as described herein enables customization of sizing and effects for the user. Traditional bras are sold in specific sizes, partly due to the excessive hardware required, while a breast tissue support device may include a variety of sizes, which can be different for each breast of a user. Such customization may be partly attributable to the lack of hardware required on the breast tissue support device. Furthermore, the stretch capabilities of the breast tissue support device and the adhesive enable the breast tissue support device to form to the natural and actual shape of the user. This customization provides an ideal form of support for each breast. Additionally, the minimal amount of hardware required for a breast tissue support device enables additional freedom of movement for the user when compared to traditional bras.

The devices and systems of the disclosure each have several innovative aspects, no single one of which is solely responsible or required for the desirable attributes disclosed herein. The various features described above may be used independently of one another, or may be combined in various ways. All possible combinations and subcombinations are intended to fall within the scope of this disclosure. Various modifications to the implementations described in this disclosure may be readily apparent to those of ordinary skill in the art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that may be described in this specification in the context of separate implementations also may be implemented in combination in a single implementation. Conversely, various features that may be described in the context of a single implementation also may be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

In general, in the following claims, the terms used should not be construed to limit the claims to the specific embodiments disclosed in the specification and the claims, but should be construed to include all possible embodiments along with the full scope of equivalents to which such claims are entitled.

1. A breast tissue support device comprising:
an elastic fabric having an exposed side and a skin side; and
an adhesive disposed on the skin side of the elastic fabric, the adhesive configured to adhere the breast tissue support device to human skin,
wherein the breast tissue support device includes a center portion free from adhesive, the center portion sized to surround a human nipple.

2. The breast tissue support device of claim 1, further comprising an infusion material infused into the elastic fabric.

3. The breast tissue support device of claim 1, wherein the elastic fabric defines center aperture at least partially coextensive with the center portion of the breast tissue support device, the center aperture configured to enable a human nipple to be placed therein.

4. The breast tissue support device of claim 1, wherein the adhesive is disposed as a plurality of waves.

5. A breast tissue support device comprising:
an elastic fabric having an exposed side and a skin side; and
an adhesive disposed on the skin side of the elastic fabric, the adhesive configured to adhere the breast tissue support device to human skin,
wherein the breast tissue support device is configured to promote lymphatic flow.

6. The breast tissue support device of claim 5, further comprising a lymphatic stimulator, the lymphatic stimulator configured to promote lymphatic flow.

7. The breast tissue support device of claim 6, wherein the lymphatic stimulator comprises a plurality of beads arranged in one or more at least partial rings radially spaced from a designated focal point.

8. The breast tissue support device of claim 6, wherein the lymphatic stimulator is configured to promote lymphatic flow in a radial direction from a designated focal point.

9. The breast tissue support device of claim 6, wherein the lymphatic stimulator is configured to promote lymphatic flow by massaging a portion of a lymphatic system adjacent to the breast tissue support device.

10. The breast tissue support device of claim 6, wherein the lymphatic stimulator comprises a plurality of beads including beads having a plurality of sizes.

11. The breast tissue support device of claim 6, wherein the plurality of beads are disposed on the skin side of the elastic fabric.

12. The breast tissue support device of claim 6, further comprising an infusion material infused into the elastic fabric and/or the lymphatic stimulator.

13. The breast tissue support device of claim 5, wherein the adhesive is disposed in a wave pattern extending radially outward from a designated focal point.

14. The breast tissue support device of claim 13, further comprising a lymphatic stimulator, wherein the lymphatic stimulator is not coincidental with the adhesive.

15. The breast tissue support device of claim 5, wherein the adhesive is absent on a nipple portion of the elastic fabric, wherein the elastic fabric is configured such that the nipple portion is configured to be positioned on a nipple of a user.

16. The breast tissue support device of claim 15, further comprising a lymphatic stimulator,
wherein the lymphatic stimulator is not disposed in the nipple portion of the elastic fabric.

17. The breast tissue support device of claim 5, further comprising an aperture extending through the elastic fabric, the aperture configured to enable a human nipple to pass therethrough.

18. A clothing article comprising:
a breast tissue support device comprising:
an elastic fabric having an exposed side and a skin side; and
an adhesive disposed on the skin side of the elastic fabric, the adhesive configured to adhere to human skin,
wherein the breast tissue support device includes a center portion free from adhesive, the center portion sized to surround a human nipple.

19. The clothing article of claim 18, wherein the breast tissue support device is configured to promote lymphatic flow.

20. The clothing article of claim 18, further comprising an infusion material infused into the elastic fabric of the breast tissue support device.
